(19) United States
(12) Patent Application Publication
(10) Pub. No.: US 2018/0074653 A1
(43) Pub. Date: Mar. 15, 2018

(54) INTERACTIVE ELECTRONIC PROJECTION DEVICE

(71) Applicant: CN2P, La Défense Cedex (FR)

(72) Inventors: Pascal POMMIER, Paris (FR); Guillaume POMMIER, Paris (FR); Nicolas CRUCHON, Ailly Sur Noye (FR); Fabien VIAUT-NOBLET, Paris (FR)

(21) Appl. No.: 15/565,320

(22) PCT Filed: Apr. 8, 2016
(86) PCT No.: PCT/EP2016/057849

§ 371 Date: Oct. 9, 2017

(30) Foreign Application Priority Data
Apr. 10, 2015 (FR) 1553162

(51) Int. Cl. G06F 3/042; G06F 3/01; G06F 3/0488; G09G 3/00; G06F 1/16

(52) U.S. Cl. CPC G06F 3/0421; G06F 3/0426; G06F 3/017; G06F 2203/04106; G09G 3/001; G06F 1/1639; G06F 3/04883

(57) ABSTRACT

A projection device for displaying interactive digital content intended to be projected onto a surface, the projection device including a projection housing including a part forming a support pedestal, the projection housing including: an emitter for emitting a light beam in a non-visible frequency band, forming a light sheet that is intended to cover a first zone of a surface; a projector for projecting an image onto a second zone; a first detector for capturing an image of the second zone; and a computer for determining at least one position of at least one interaction point of the light beam by analysis of a trace of the image acquired by the first detector.

### FIELD

The field of the invention relates to interactive projection devices enabling the projection of an image and offering interactivity on a zone of the projected image.

### PRIOR ART

An electronic bracelet currently exists making it possible to carry out a projection of images. This solution is described in the patent application US2015/0054730. On the other hand, the mode of detecting interactions with the image has drawbacks. Indeed, false detections may arise due to the incorrect assessment of the position of a finger. Furthermore, such a solution encounters difficulties of implementation both in the precision of detecting interaction zones and in the quality of the projection offered on a relatively small zone.

Projection devices exist but interactivity is often difficult to implement in a robust manner and enabling good precision.

There exists a need for an image projector which enables interactivity on activatable zones of a projected image.

### SUMMARY OF THE INVENTION

The invention aims to make up for the aforesaid drawbacks.

An object of the invention relates to a projection device for displaying interactive digital content intended to be projected onto a surface. The device of the invention comprises a projection housing. The projection housing comprises:
An emitter of a light beam in a non-visible frequency band forming a light sheet intended to cover a first zone of a surface;
A projector for projecting an image onto a second zone;
A first detector for capturing an image of the second zone;
A computer for determining at least one position of at least one interaction point of the light beam by means of the analysis of a trace of the image acquired by the first detector.

An object of the invention relates to a projection device for displaying interactive digital content intended to be projected onto a surface, characterised in that it comprises a projection housing comprising a part forming a support pedestal. The projection housing comprises:
An emitter of a light beam in a non-visible frequency band forming a light sheet intended to cover a first zone of a surface;
A projector for projecting an image onto a second zone;
A first detector for capturing an image of the second zone;
A computer for determining at least one position of at least one interaction point of the light beam by means of the analysis of a trace of the image acquired by the first detector.

The emitter and the first detector are arranged on a lower part of the projection housing and the image projector is arranged on an upper part of the projection housing, said projection housing comprising a means of rotation making it possible to pivot the upper part of the projection housing along a vertical axis with respect to the lower part of the projection housing.

According to one embodiment of the invention, the projection housing comprises a first side comprising the image projector on an upper part of the projection housing and a second side opposite to the first side on which the emitter and the first detector are arranged on the lower part of the projection housing, said emitter projecting the light sheet in a direction opposite to the image projection direction.

According to one embodiment of the invention, the projection housing comprises a first side comprising the image projector, the emitter and the detector, the emitter projecting the light sheet in a direction substantially parallel to the image projection direction, in such a way that the first zone is substantially superimposed on the second zone.

According to one embodiment of the invention, the image projector is arranged on an upper part of the projection housing and the emitter is arranged on a lower part of the projection housing.

According to one embodiment, the projection housing comprises a means of rotation making it possible to pivot an upper part of the projection housing along a vertical axis with respect to the lower part of the projection housing.

According to one embodiment, the detector records images comprising at least one interaction trace when the beam is intercepted by a body, the computer generating interaction instructions modifying the projected image as a function of a detected interaction zone.

According to one embodiment, the upper part of the projection housing is removable with respect to its lower part, the upper part of the projection housing being an electronic bracelet comprising an image projector and the lower part being a pedestal for supporting said bracelet.

According to one embodiment, the bracelet comprises a band intended to be maintained around a wrist, a power supply source and a bracelet housing arranged and maintained on an upper part of the bracelet, said bracelet housing comprising the emitter, the projector, the first detector and the computer.

According to one embodiment, the projection device comprises:
A component making it possible to apply deformation factors to the projected image in order to compensate:
   a perspective deformation taking into consideration:
      lateral deformations of the projected image;
      depth of field deformations of the projected image.

According to one embodiment, the projection device comprises:
A component making it possible to apply deformation factors to the projected image in order to compensate:
   a surface deformation linked to the anatomy of the forearm when the removable housing is a bracelet and/or;
   a perspective deformation taking into consideration:
      lateral deformations of the projected image;
      depth of field deformations of the projected image.

According to one embodiment, the computations of transformation factors are computed after calibration of the image. According to another embodiment which may be combined with a calibration step, the computations of transformation factors are computed automatically in real time as a function of the image correction factors to apply to the transformation factors.

According to one embodiment, the emitter of the light beam is an infrared emitter.

According to one embodiment, the emitter is a linear emitter projecting a substantially flat light beam.

According to one embodiment, the emitter is arranged on the lower part of the projection housing.

According to one embodiment, the lower part of the device is the pedestal 5 and an upper part comprises the parts 2 and 3.

According to one embodiment, the emitter is arranged on the bracelet housing on the first side, at a height situated between the projector and the band of the bracelet.

According to one embodiment, the first detector comprises a sensitivity range making it possible to detect a trace caused by an interception of the light beam with a body.

According to one embodiment, the first detector is an infrared detector for capturing an image in which the light beam forms an image of which the longitudinal dimensions, that is to say in the projection direction, are identifiable.

According to one embodiment, the first detector is an infrared detector for capturing an image in which the light beam forms an image of which the longitudinal dimensions, that is to say in the projection direction, are identifiable.

According to one embodiment, the first detector is arranged on the lower part of the projection housing between the upper part of the projection housing and the emitter.

According to one embodiment, the position of at least one interaction point is computed from:
a transformation of the image and the trace acquired into an original image comprising an image of the trace from transformation factors;
a geometric construction of an interaction point of at least one trace or image of the trace.

According to one embodiment, the computer compares the position of the interaction point with a matrix of points delimiting interaction zones in a frame of reference linked to the original image, the computer deducing a probability of interaction with an interaction zone.

According to one embodiment, the device further comprises a second detector for capturing colorimetric images of the second zone. The second detector may be arranged for example on the upper part of the projection housing. It may be co-localised with the projector, that is to say substantially at the same vertical position. According to another embodiment, it may be arranged on the part forming the tower of the projection device or instead on the pedestal of said device.

According to one embodiment, the projection device comprises an image stabiliser, said image stabiliser comparing the images acquired by the second detector with the dimensions of a reference image and generating corrective factors to apply to the image deformation factors as a function of the image comparison.

According to one embodiment, the image stabiliser compares the longitudinal dimensions of the second zone of images acquired by the first detector with the dimensions of the images acquired by the second detector to generate correction factors to apply to the transformation factors.

According to one embodiment, the second detector carries out a second computation of an interaction point by means of the analysis of a trace intercepting the image, said trace being obtained by means of the analysis of a modification of the colour of the pixels of a portion of the acquired image.

According to one embodiment, a computer correlates the position of an interaction point obtained from an image acquired by the first detector and the position of an interaction point obtained from an image acquired by the second detector, the correlation of the positions making it possible to generate a new position of an interaction point.

According to one embodiment, the image projector is a colour pico-projector.

According to one embodiment, the image projector comprises a blue laser, a red laser and a green laser and a set of micro-mirrors oriented so as to produce, at each projection point, a point of which the colour is generated by a combination of the three lasers oriented by the mirrors.

According to one embodiment, the image projector is a LCOS type projector.

According to one embodiment, the image projector emits an image, the resolution of which is 1920×2080.

According to one embodiment, the projection device comprises an accelerometer and a gyroscope making it possible to activate functions generating a modification or a change of the image projected by the projector.

According to one embodiment, the power supply source is a removable battery.

### BRIEF DESCRIPTION OF THE FIGURES

Other characteristics and advantages of the invention will become clear on reading the detailed description that follows, with reference to the appended figures, which illustrate:

FIG. 1: a front view of an electronic bracelet comprising a projector of the invention;

FIG. 2: an arm of a user wearing a bracelet of the invention;

FIG. 3: a lateral sectional view of the bracelet of the invention and a mode of projection of an image;

FIG. 4: a representation of a gridding used to detect an interaction point on a projected image;

FIG. 5: a superimposition of an original image and a matrix of delimitation points for the computation of an interaction zone;

FIG. 6: a projection device of the invention according to a first configuration;

FIG. 7: a projection device of the invention according to a second display configuration.

### DESCRIPTION

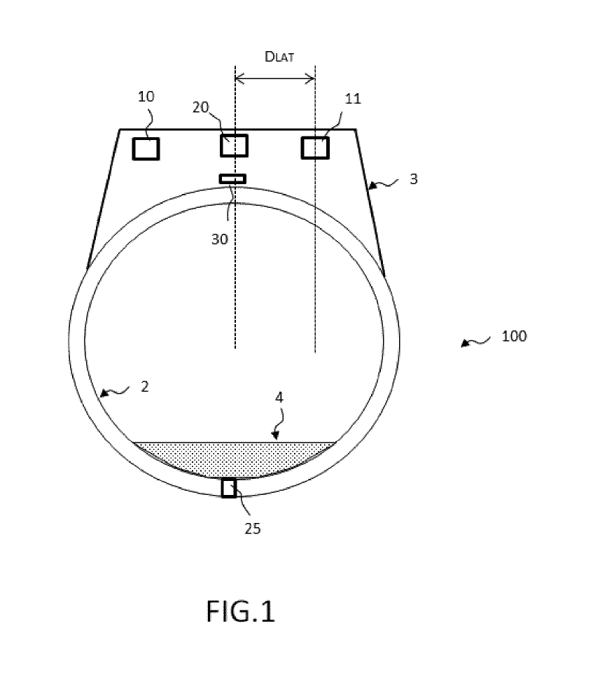

FIGS. 1 to 5 represent a particular embodiment of the invention wherein the projection device 1 of the invention comprises a removable upper part comprising an electronic bracelet 100. This embodiment is a particular embodiment of the invention in so far as the electronic bracelet 100 may be advantageously worn by a user according to a first usage and may be positioned on a pedestal 5 for a second usage. The bracelet of the invention 100 is intended to cooperate with a pedestal 5 thereby forming a projection housing 2, 3, 5.

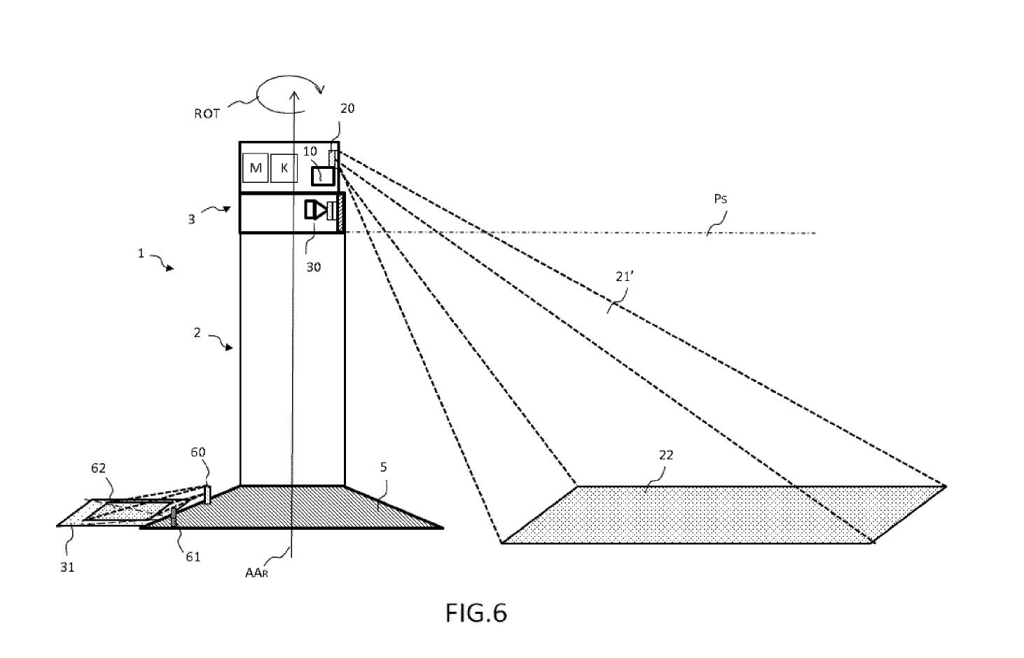

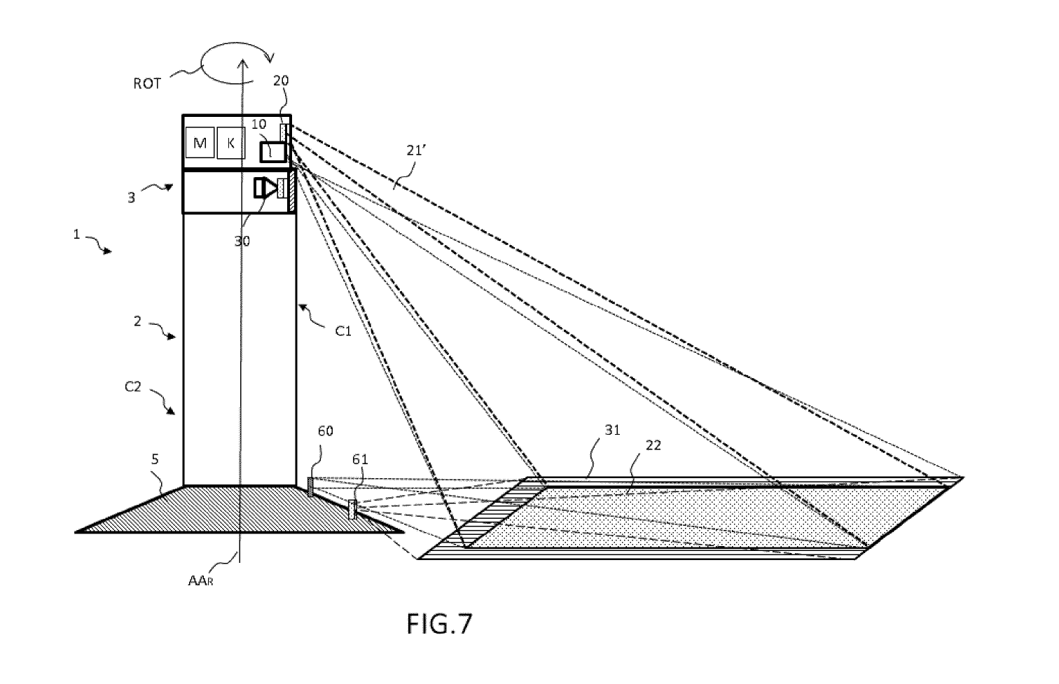

FIGS. 6 and 7 represent a more general embodiment of the invention wherein the housing 2, 3 forms a projection tower which may optionally comprise a pedestal 5. The object of the invention firstly comprises the projection device 1. According to one embodiment, a part of its housing 2, 3 may be a bracelet cooperating with a pedestal 5.

The description firstly describes the first usage by a description of an electronic bracelet 100 which may be positioned on a pedestal 5. Common operating principles, including notably the detection of an interaction point or the pairing with Smartphone type equipment are described in light of this first usage and are applicable to the second usage. Thus the first and the second usages are described jointly for the common parts in the first usage of the projection device of the invention.

FIG. 1 represents an embodiment of a bracelet 100 of the invention. The bracelet comprises a housing 3, a band 2 and a power supply source 4.

### Band

The band 2 forms the part of the bracelet making it possible to maintain said bracelet around the wrist of a person. It may comprise a means 25 of adjusting the attachment position of the band in order to adapt itself to different wrist circumferences. The means 25 of adjusting the position of the bracelet 100 may also make it possible to fasten two parts of the band around the wrist together. The band may be made of flexible elastic material, fabric or instead made of rigid material such as a rigid plastic material, metal or made of foam or instead any other material making it possible to form a band. The band 2 may comprise a small thickness of the size of a watch bracelet of several millimetres or instead be thicker of the order of 1 or 2 cm.

The lower part of the bracelet 100 is designated as a part opposite to the part of the bracelet 100 comprising the housing 3 corresponding to the upper part of the bracelet 100.

### Power Supply Source

According to one embodiment, a power supply source 4 is positioned in the lower part of the bracelet 100 so as to make the housing 3 less bulky in volume and in such a way as to balance by weight and/or aesthetically the bracelet 100 of the invention on either side. Thus the bracelet 100 may find a better balance when it is maintained around a wrist. According to this embodiment, the power supply connector(s) supplying the electronic components of the housing may be routed along the band 2 for example inside the band 2 so as to be hidden from the outside.

According to another embodiment, the power supply source 4 is arranged on the upper part of the bracelet 100. For example, the housing 3 may comprise the power supply source 4. According to another example, the power supply source may be comprised in another housing placed side by side or juxtaposed with the housing 3 on the upper part.

According to one embodiment, the power supply source is a rechargeable battery. The battery may then be removable and thus be removed from the bracelet 100 to be recharged. Another solution consists in placing the bracelet 100 on a pedestal comprising a power supply enabling the recharge of the battery which remains in position in the bracelet. According to another mode, the power supply source is a replaceable battery.

### Housing

According to one embodiment, the housing 3 comprises an infrared emitter 30. The emitter 30 then emits a light beam 31 forming a light sheet. Advantageously, the emitter 30 is arranged in the lower part of the housing and may be a linear emitter. The lower part of the housing 3 is defined as the part the closest to the skin of the wrist or the forearm or the hand of a person wearing the bracelet 100. According to other modes of uses and according to the different ways of wearing the bracelet of the invention, the display may be produced on the front face or the rear face of the forearm. In an analogous manner, the projection of images may be carried out on the inside or the outside of the hand. One advantage is to produce a substantially flat beam as near as possible to the skin and substantially parallel to the surface of the wrist or the forearm.

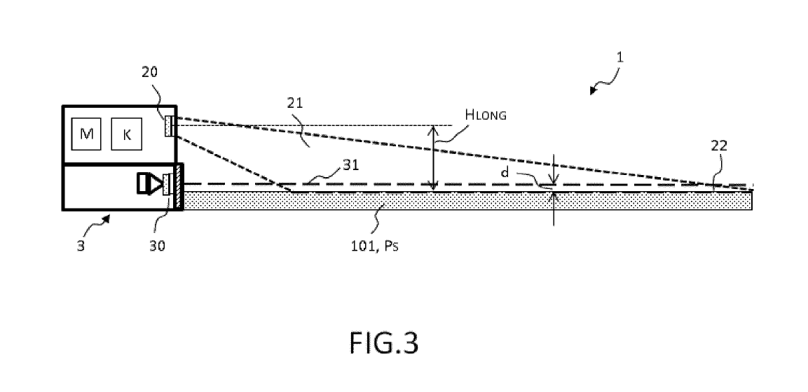

FIG. 3 represents a sectional view wherein the beam 31 is parallel to the surface of the forearm 101 and situated at a height d.

According to one embodiment, the housing 3 comprises a projector 20 making it possible to project an image along an axis intercepting the wrist or the forearm of a person who is wearing the bracelet 100. FIG. 3 represents in sectional view a portion of the projection cone 21 intercepting the forearm 101 to form an image 22. The projector is arranged in the housing at a height noted H_{LONG} from the surface of the forearm 101.

According to one embodiment, the housing 3 comprises a first detector 10 for detecting in the infrared domain the modifications of colours linked to interactions of the beam emitted by the emitter 30.

According to one embodiment, the housing 3 comprises a second detector 11 for detecting images emitted in the visible frequency domain to adjust in real time the size of the image and/or to calculate in real time the deformation factors to apply to the projected image.

According to one embodiment, the housing 3 comprises computing means, noted M in FIG. 3, such as a computer which may be a microprocessor, a microcontroller or an electronic chip. The computing means may comprise, according to the chosen embodiment, one or more computers fulfilling the different image processing functions. These functions include the generation of images and the computations of image deformation and/or correction factors. Moreover, the computer makes it possible to carry out computations of positions of interaction points and closed-loop control of generation of new images as a function of the detected commands. The computer is thus capable of generating the images to project as a function of the detected interactions, as well as all other functions necessary for the realisation of the invention.

According to one embodiment, the housing 3 comprises one or more memories, noted M in FIG. 3, for temporary recording computed values or for storing information of interactions as positions of interaction points or instead for storing data making it possible to generate images or any other data necessary for the realisation of the invention.

According to one embodiment, the housing 3 comprises an accelerometer and a gyroscope for measuring movements of the wrist and/or the forearm of a person wearing the bracelet 100. The detected movements may be detected by comparing acceleration values with reference to known and recorded values, which correspond to actions to carry out. As an example, the lighting up of the bracelet may be carried out by turning the wrist twice in a row along the axis of the forearm. The acceleration values measured over a given time period make it possible to determine which action has to be undertaken as a function of the detected movement sequence.

According to another example, a wakening action may be undertaken to light up the bracelet 100 when a rotational acceleration threshold around the forearm has been exceeded.

Other actions may be indicated according to acceleration values measured along the three axes of a Cartesian frame of reference to generate specific actions such as for example: activating a detector or a projector, switching off a detector or a projector, generating an image or modifying the image generated, activating a new image from a first image as a function of a browsing history.

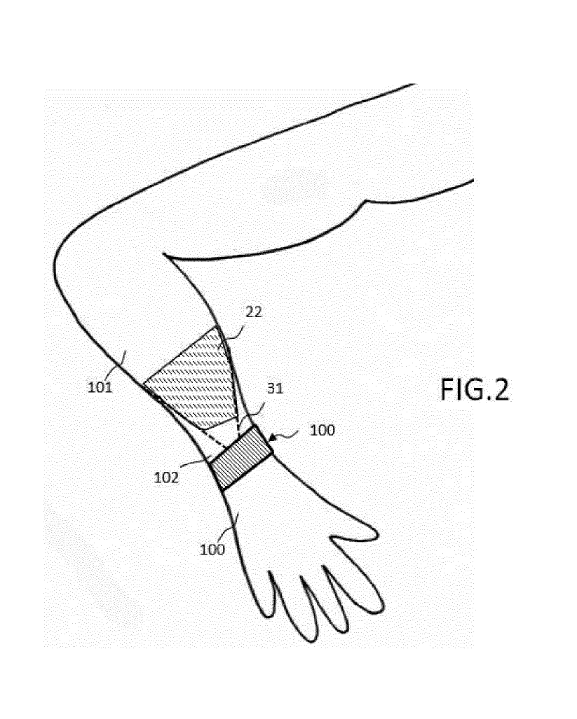

FIG. 2 represents a bracelet 100 of the invention positioned in a portion of the arm situated between the forearm 101 and the hand 100. This junction zone is designated as the wrist 102. This zone is advantageously intended for the wearing of the bracelet 100 of the invention. The bracelet 100 is represented projecting an image 22 onto the forearm 101 of a person. The infrared light beam 31 is also represented superimposed on the image displayed on the forearm 101.

According to another embodiment, the display of the image 22 and the generation of the beam 31 may be carried out on the hand. To do so, a mode makes it possible for example to turn over the bracelet 100 and to reverse the display in order to activate the direction of projection of the image 22 towards the hand while benefiting from an image displayed in the reading direction. According to another embodiment, the bracelet is configured for a display towards the direction of the hand. However, this display mode does not offer the entire projection surface of the forearm 101. The fingers and notably the carpal bones limit the display zone and cause a deformation of the displayed image. Furthermore, movements of the hand 100 are often more abrupt and more sporadic than those of a forearm 101, hence, the image stabiliser has to be more reactive and has to be configured so as to take into account these hand movements.

In the remainder of the description, the display mode in the direction of the forearm 101 is described and corresponds to a preferred mode of the invention.

### Detection of Interaction Points

The beam 31 is preferentially emitted in a non-visible frequency band so as not to alter the image 22 projected by the projector 20. According to one embodiment, the light beam is emitted by a linear emitter generating a substantially flat beam in an infrared frequency range. The beam is emitted along a plane substantially parallel to the surface of the skin between 1 mm and 1 cm from the surface of the skin. A distance between 1 mm and several millimetres makes it possible to obtain good detection efficiency on the projection zone while limiting false detection errors.

In one embodiment, a module for managing the power of the beam emitted may be integrated in the housing. A command accessible by a user which may be either digital or by means of a discrete allows him to adjust the power of the beam. This command makes it possible to adjust for example a night mode or a day mode. By default, the power is configured in such a way as to offer good detection by day and by night.

A detector 10 makes it possible to acquire in a given range of frequencies at least one trace 32 formed by the interception of the beam by a body. In nominal use of the bracelet 100, the body intercepting the beam is generally the finger of a user which is positioned on a zone of the displayed image. An advantage of the bracelet 100 of the invention is to reproduce interactivity comparable to that of smartphones or tablets which comprise a touch screen but without the use and the bulk of such a screen. Another body may be used, such as for example a stylet. When the body is a finger, an advantage of the invention is that the interaction may be detected even with the use of a glove, which a touch screen does not allow.

When a body intercepts the light beam 31 at one point at least, the detector 10 captures a luminous variation which may result in the presence of a white patch when the beam is an infrared beam. The detector 10 thus makes it possible to generate an image comprising a trace 32 having coordinates in the acquired image corresponding to the interaction point that the user wishes to engage by an action of his finger. It may be recalled that the user does not see the infrared beam 31 but uniquely the projected image 22. Thus the bracelet offers command interactivity that is transparent for the user. The interaction point thus corresponds to a zone of the image that he wishes to activate. The activation may correspond to the desire to browse on another page by activating a link or may correspond to a choice among a list of choices or an option that is displayed and which has to be validated. Other examples of activations may be envisaged according to the bracelet 100 of the invention.

An advantage of the layout of the detector 10 which is positioned at a height higher than the beam emitter 30 on the housing of the bracelet 100 with respect to the surface of the wrist is to obtain good image taking, reflecting traces linked to the interception of the beam by a body. Other systems exist for evaluating the position in depth of an interaction such as for example a “radar” type operation, but these latter solutions remain approximate and do not make it possible to discriminate a lot of points on the interaction zone. These latter devices generate numerous false detections on account of the imprecision of the evaluation of the distance of the body to the detector. An advantage of the bracelet of the invention is to propose a layout of the detector offering a perspective of detection of the displayed image. This configuration improves the detection of an interaction point and the precision of the determination of the coordinates of the centre of the interaction point.

According to the embodiments of the invention, the determination of the interaction point may be carried out in the frame of reference linked to the projected image or in the frame of reference of the acquired and transformed image. The two alternatives are substantially equivalent and offer comparable results. One or the other of these methods comprises specific advantages which may be chosen according to the envisaged design. As an example, when the computations of positions are carried out in the frame of reference of the image displayed on the forearm, the computations linked to the matrices of transformations of the detected patch are simplified. On the other hand, when the computations of positions are carried out in the frame of reference of the acquired and transformed image, a gain in precision may be obtained on the determination of the centre of the detected patch and the determination of the activated zone of the image.

The bracelet 100 or the projection device 1 of the invention thus enables the analysis of at least one position of an interaction point of a user to determine which zone of the image will be activated. Indeed, the image may comprise interaction zones. Software cutting of the image makes it possible to segment the image into different interaction zones. The invention then makes it possible to compare the position of the interaction point of the beam with reference points and to identify to which interaction zone of the image this point corresponds.

To do so, the bracelet 100 of the invention makes it possible to transform the image acquired by the detector 10 into a known frame of reference of a non-deformed image. In this frame of reference, the projected image before the application of deformation factors or the image acquired after the application of deformation factors is designated as original image.

Different deformations may be applied to the acquired image to switch it to a format linked to the original image. The deformations applied to the image during projection allow a user to view the image as if it was displayed while conserving the proportions of an original image. Conversely, the deformations applied during the acquisition of images make it possible to take into account differences linked to the fact that the plane of detection is not parallel to the plane of the image and perspective effects.

A first transformation may be applied to compensate the lateral offset D_{LAT} of the detector 10 with respect to the central projection axis.

A second transformation may be applied to compensate the perspective effects of the projected image in depth and to apply a transformation aiming to re-establish the image acquired in a 2D plane. The perspective effects may take into account the height between the detector 10 and the plane of the projected image 22 substantially parallel to the plane forming the forearm 101. The acquired image may then be transformed to compensate this difference. Moreover, lateral perspective effects may be taken into account by the transformation factors as well as edge effects of which notably the part of the image the closest to the bracelet as well as the part the furthest away.

A third transformation may be applied to compensate surface effects linked to the anatomy of the forearm or the hand that would be taken into account in the projection of the projected image 22.

The trace 32 detected in the acquired image may be transformed in such a way as to obtain a trace 32′ in a frame of reference of a non-deformed image by the projection of the latter on the forearm. The non-deformed image is designated as the original image as mentioned previously.

The trace 32′ in the original image comprises one or more pixels in the frame of reference of the original image.

A step of determining the centre 33 of this trace 32′, or a barycentre, may be undertaken to determine the most likely interaction point of the image that a user has wished to activate. The point thereby computed, designated as “centre of interaction” 33, may be a pixel of the image.

A step of comparing the position of the centre of interaction 33 with the original image makes it possible to determine the action to undertake by the computer.

According to an alternative embodiment, the centre of interaction may be computed on the acquired image not yet corrected by the transformation factors. In this case, the transform of the centre of interaction of the trace of the acquired image makes it possible to determine the position of the centre of interaction of the trace of the original image.

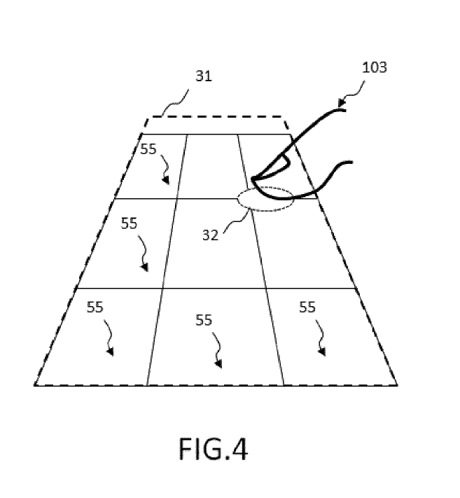

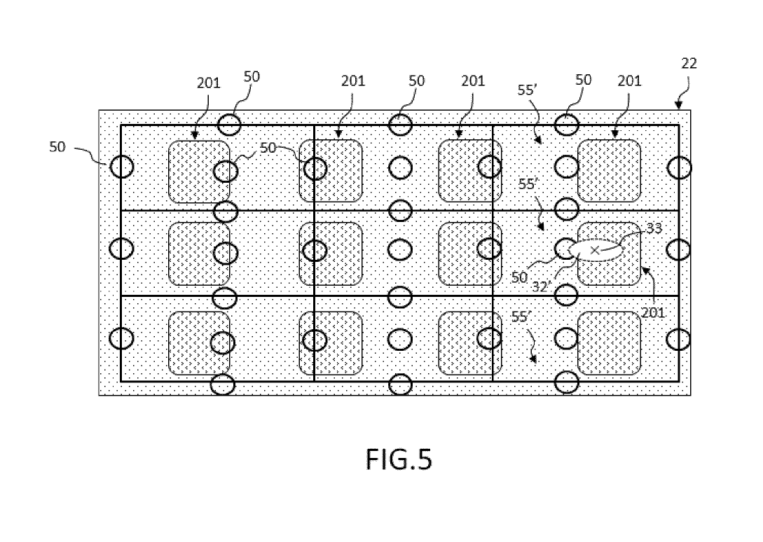

According to one embodiment, the position of the centre of interaction 33 is compared with a matrix of points delimiting zones 55 or 55′ depending on whether the acquired image or the original image obtained by the transformation of the acquired image is considered. Such zones 55 are represented in perspective in FIG. 4 and superimposed on the beam 31 and are represented in the original image in FIG. 5.

Delimitation points 50 are defined in order to delimit the interaction zones 55′.

FIG. 5 represents the zones 55′ in a frame of reference linked to the original image as well as the delimitation points 50. To do so, the image is delimited in zone 55′ by a gridding in the frame of reference linked to the original image. According to one embodiment, the gridding has identical rectangular surfaces. But any other gridding is compatible with the bracelet 100 of the invention. According to other alternative embodiments, zones 55′ forming squares, diamonds or circles may be defined. The position of the centre of interaction 33 is thereby compared to the position of the delimitation points 50 or to the limits of the zones 55′. An algorithm making it possible to compute the distances from the centre of interaction 33 to the closest delimitation points 50 makes it possible to estimate the zone 55′ that is activated by the user. When a trace “straddles” two zones 55′, the bracelet of the invention is configured to determine the proportion of the patch in each of the zones. According to one embodiment, the zone 55′ comprising the greatest number of pixels of the trace 32′ is determined as the active zone.

Advantageously, in this embodiment, the display of the image comprises activatable zones, the activation of which is determined as a function of the computation of the position of the centre of interaction 33 in the image.

FIG. 5 represents icons 201 of the original image. In this example, the computation of the trace 32′, or its centre 33, in the frame of reference of the original image may be brought closer:
either directly to the closest position of the icon 201, thus having the closest pixels or pixels in common with the trace 32′;
or to a zone comprising this graphic icon, the identification of the zone thus leading to the identification of the icon comprised in this zone.

Thus, the use of zones remains optional. When the position of the centre of interaction is directly compared with zones of interest of the image, it is possible to determine which action has to be undertaken. The use of zones makes it possible to make the detection of interaction points more robust by carrying out a simple comparison with the zone concerned corresponding to the determined interaction point. The comparison makes it possible to end up with an action which is linked to the activation of said determined zone.

Other actions combining different interaction points 33 may be detected according to the same principle by the bracelet 100 of the invention.

As an example, two interaction points 33 may be detected. When these two interaction points 33 make a relative movement towards each other or move away from each other, this may correspond to an enlargement or to a contraction of the image or a zone of the image to display. In this embodiment, the detection of movements comprises the detection of a set of interaction points. Instantaneous vectors may be deduced. When two interaction points are in movement, it is possible to compare the directions of the instantaneous vectors and to generate an instruction for activating a function. To this end, the computer makes it possible for example to enlarge a portion of the image or the entire image depending on the position of the determined centres of interaction.

### Projection of Images

FIG. 3 represents the projector 20 projecting an image onto the forearm 101. The projection makes it possible to deform an original image by applying deformation factors to the image. These deformation factors take into account perspective effects. These perspective effects may take into account notably the depth of field, that is to say the delimitation of the image to display on the part the furthest away from the bracelet 100 and take into account the height of the projector with respect to the projection plane situated on the skin of the forearm 101. Moreover, the image transformation factors to compensate perspective effects take into account the lateral deformation of the image, that is to say the points of the image the furthest away laterally from the main optical axis.

Optionally, the deformations take into account the anatomy of the surface of the forearm or the hand of a user according to the morphology thereof. As an example, an average or standard morphology is applied to an image projected by the bracelet 100 and may be adjusted according to the different morphologies of users. Correction factors of the transformation factors may be applied to modify the transformations applied to the projected image.

An objective of the image transformation factors is to display an image on the forearm of a user which is close to an original image for the user. It is then necessary to compensate certain natural deformations linked to the mode of projection of images and to the projector itself.

The computer of the bracelet of the invention or of the projection device 1 may make it possible to perform image processing computations notably the application of deformation and/or correction factors. Another computer may be used to generate the images. According to one embodiment, a same computer generates the images and transforms the images from deformation and/or correction factors.

The projector may be a laser projector of colour laser pico-projector type.

According to one embodiment, the image projector comprises a blue laser, a red laser and a green laser and a set of micro-mirrors oriented so as to produce, at each projection point, a point of which the colour is generated by a combination of three lasers oriented by the mirrors.

According to another embodiment, the image projector may be to this end a LCOS (Liquid Crystal On Silicon) type projector. This technology makes it possible to mix a light source with a light source. The light source may be generated by one or more laser(s) or one or more diode(s). A liquid crystal screen may be directly mounted on an integrated component. A prism may also be used.

According to one embodiment, called high definition, the image projector emits an image, the resolution of which is 1920×2080.

### Second Detector 11

According to one embodiment, the bracelet 100 or the projection device 1 comprises a second detector 11 making it possible to acquire colour images. The second detector makes it possible to apply corrective factors to the transformations to apply to the projected image. Notably, an analysis of the contours of the projected image makes it possible to readjust the transformation factors to apply to the projected image. To do so, corrective factors are applied to the transformation factors to take into account the real display detected on the forearm.

The second detector 11 makes it possible to improve, notably, the image stabiliser function. The contours of the displayed image 22 may be regularly compared to a control image having desired nominal dimensions, the characteristics of which are recorded in a memory M. This comparison in real time of the dimensions of the displayed image and that recorded makes it possible to generate corrective factors. The correction factors may thus be generated as a function of the differences computed by a computer between two image dimensions.

These correction factors make it possible to compensate movements of the wrist, the hand and the forearm. Moreover, these correction factors also make it possible to compensate an inclination of the housing when the bracelet comprises play around the wrist. The correction factors make it possible to offer an image stabiliser function to a user.

Moreover, the dimensions of the images captured by the two detectors 10 and 11 may also be compared to ensure coherence of the image stabilisation and the detection of interactive zones of the image.

Finally, the second detector 11 also makes it possible to carry out a second computation for detecting a centre of interaction or an interaction zone. The positions obtained by the two detectors coupled to one or more computers may be correlated in order to reduce the level of false detections.

An image calibration may be defined by means of the bracelet 100 or projection device of FIGS. 6 and 7. The image calibration aims to project a control image and to apply transformation factors depending on the desires of a user. To this end, the bracelet of the invention comprises an interface comprising buttons or contactors making it possible to apply modifications of image correction or deformation factors. Thus, the calibration makes it possible to ensure that the image is displayed suitably for a user, that is to say in a substantially rectangular format compensating perspective effects. The calibration makes it possible to adapt the format of the image to a given morphology of a user. One advantage is to determine a display format and next to conduct corrections in such a way as to compensate movements during use of the bracelet. Another advantage is to enable the calibration phase at any moment, thereby making it possible to compensate drifts or changes of anatomy. It is also possible to personalise the display depending on the user, the bracelet then being able to be preconfigured according to different calibrations and thus to be used by different persons.

According to one embodiment, the bracelet 100 comprises a fabric which can be spread out on the forearm to form a screen. The fabric may be integrated in the band 2 or in the housing 3 or instead in the compartment 4 which comprises the battery. The fabric may be maintained at its end by an elastic or a second bracelet which is fastened to the arm to tighten it.

According to an alternative embodiment, the bracelet 100 extends longitudinally for example by means of superimposed concentric rings. A locking and unlocking system makes it possible to change to an extended mode of the bracelet 100 and to lock it. The rings are then designed to be maintained for example thanks to diameters cooperating at the ends between two superimposed rings. The device for elongating the bracelet 100 is then similar to a “fishing rod” type deployment device. Similarly, the rings may be portions of unclosed rings which only cover part of the forearm. One advantage is to form a screen superimposed on the skin of the forearm. This embodiment notably makes it possible to be able to ignore the surface topology of the forearm of a person, hairs and different thicknesses of forearm.

### Pairing

According to one embodiment, the bracelet 100 of the invention or the projection device 1 may be paired with equipment connected to a mobile or terrestrial network such as a Smartphone, a tablet or a computer. A wireless link is advantageously exploited to pair the devices together. The wireless link may be established thanks to a Bluetooth or Wifi protocol or any other protocol making it possible to achieve such a link. The bracelet of the invention comprises to this end a radio or network component making it possible to establish such a connection. The computer present in the bracelet of the invention is configured to process the data received from the equipment and to process the images to project them.

According to one embodiment, the image projected by the bracelet of the invention is an image generated by the equipment and transmitted by the wireless link to the bracelet.

According to one embodiment, when an interaction on the image displayed by the bracelet is detected, the bracelet processes the interaction independently of the equipment for example by offering an interactive menu and by validating a choice of the user or by actuating a button making it possible to generate a second image. To do so, the bracelet is for example capable of directly generating a request to a network equipment via an access to a network independently of the equipment. According to another case, the bracelet comprises a memory in which the data to display are saved. Other interactions may be envisaged according to alternative embodiments, which may be combined together.

According to another embodiment, the bracelet of the invention is configured to generate a request to the equipment in order to process the interaction detected on the displayed image. The bracelet is thus then used as an alternative for displaying the equipment such as a Smartphone. If for example a button displayed on the forearm is activated, the request generated to the equipment makes it possible to return an action or an image to the bracelet. The latter will also be able to project the result of the interaction.

### Network Connection

According to one embodiment, the bracelet 100 or the projection device 1 comprises a network component making it possible to connect to a network. The connection may be made, for example, by a wireless link such as a Wifi or Bluetooth link or any other protocol making it possible to establish a wireless link. As an example, the bracelet may be configured to connect to an internet box through a Wifi network or a 3G or 4G mobile network. The bracelet is then capable of generating requests via the box through the network to interface with a server. Thus the bracelet is a connected bracelet which makes it possible to display for example a digital content coming from the internet network. In this case, a video of a video platform may be displayed on the forearm thanks to the reception of video frames and their processing by the computer of the bracelet and the image projector.

FIG. 6 represents another embodiment of the invention wherein:
the bracelet 100 may be affixed and/or fastened onto a support 5 forming a support pedestal or;
the projection housing 2, 3, 5 forms a tower comprising a projector, an IR emitter and a detector.

When the bracelet is affixed on the pedestal it fulfils the functions of projection tower, the object of the invention and corresponds to the parts of the projection housing 2 and 3.

Let us consider the case where the bracelet is affixed on the pedestal in a first instance.

In this embodiment, a second display mode may be engaged by a user. The image obtained may in this case be of larger dimensions notably obtained by obtaining a larger interception surface between the cone 21′ and the display surface.

It may be noted that the pedestal may comprise its own power supply source in order to supply the bracelet 100 or to recharge the battery 4 of the bracelet 100.

According to one embodiment, the pedestal comprises an emitter 61 of an infrared beam and a detector 60 making it possible to acquire an image 62 and to detect the interaction points of a finger in an interactivity zone. Advantageously, the interactivity zone is projected from the other side of the bracelet 100 with respect to an image projection 22 as it is represented in FIG. 5.

The user may thus use his finger as a mouse to animate a cursor displaying on the image or to activate a zone of the image 22. Thus, a user does not need to interfere with the projected image with his hand to interact with the image. The computer K makes it possible to take into account the movements or the actions taken by a finger interacting on the interactivity zone 62 to generate actions on the image 22 to display. The actions that the computer may undertake may notably include according to the invention: a modification of the image, a validation of a choice to generate a request with a server for example, the generation of a new image, the activation of a menu or a button, etc.

This embodiment is particularly advantageous for projection onto a wall, or onto a train or airplane tray table. It further makes it possible to stabilise the image and to offer improved viewing comfort.

An object of the invention relates to a projection device as represented in FIG. 6. In this embodiment, the housing 2, 3 is not necessarily an electronic bracelet.

A first configuration is represented in FIG. 6, the infrared emitter 61 and the detector 60 are arranged on a second side C2 opposite to the first side C1 wherein is arranged the projector. In this case, the projection zone Z1 forming a light sheet, preferentially invisible for the user, makes it possible to produce a pad. A pad may be understood as a zone of interactivity on which a user can interact to activate functions, displace an image, control a cursor which is displayed on the image. The detector 60 is capable of detecting the points of displacement of a body such as a finger of a person.

The detector 60 may be arranged just above along the vertical axis of the emitter so as to benefit from the perspective effects of the emitted beam and to acquire an image, the dimensions of which make it possible to detect an interaction point on the original image. It will be recalled that the original image is the image deformed by the projection. It is the image generated by the processor or the computer generating the images before the latter is deformed by the image deformation factors.

To improve the detection of an interaction point, according to one embodiment, the detector may be situated in the upper part of the projection housing 2, 3.

Since the interaction point is computed on the image 62, it is possible to generate a cursor at a position of the displayed image 22. Thus, movements of a finger on the image 62 may be fed back by the generation of movement of a cursor that is displayed on the image 22. To do so, the computer transposes the coordinates of the interaction point computed in the zone Z1 of the image 62 acquired by the detector 60 into the image projected by the projector 20.

FIG. 7 represents an embodiment wherein the projection of images 22 is carried out in the same direction as the emission of the light sheet 31. Thus the interactions of a user may be directly carried out on the displayed image 22. The light sheet 31 in this case is superimposed on the displayed image 22, thereby giving the illusion to the user that he interacts directly on the image 22.

In this case, the emitter 61 is preferentially arranged on the lower part of the projection housing, for example on the pedestal 5, so that the light beam 31 is emitted parallel to the projection surface and as close as possible to said surface.

According to one embodiment, the detector 60 is positioned a little higher than the emitter along the vertical axis defining the axis along which the housing extends vertically. The height offset makes it possible to benefit from the formation of an image acquired by perspective effect. According to an alternative embodiment, the detector 60 may be arranged on the pedestal 5 or instead on the housing 2, 3 forming the projection tower. When the detector 60 is arranged on the lower part of the projection housing 2, 3, 5, one advantage is to get away from the detection of the hand of a user being superimposed on the image. Given the capture angle of the detector 60, as is represented by the dotted lines of the capture zone of the detector 60 of FIG. 7, it will be understood that a finger intercepting the beam 31 will indeed be detected without taking into account the hand of a user.

FIG. 7 represents a detector 10 arranged on the part 3 of the housing of the projection device of the invention. At this height, the acquisition of the image making it possible to deduce the interaction point makes it possible to obtain an important image and to obtain good precision of the interaction point.

According to one embodiment, the projection device comprises a removable part. For example, the upper part of the housing may turn around an axis of rotation AA_{R}. In this exemplary embodiment, the part 2, 3 turns around this axis, the pivoting being carried out with respect to the pedestal 5. The pedestal 5 not having moved during this rotation, this embodiment enables the passage from a display and interaction mode to a second display and interaction mode. It is thus possible to pass from the embodiment of FIG. 6 to the embodiment of FIG. 7 by turning the parts 2, 3 of the projection housing.

According to one embodiment, the rotation of the lower part, such as the pedestal with respect to the upper part, defines an angle between the axis of projection of the light beam 31 and the axis of projection of the image 22. According to one embodiment, this angle may be 180° as is represented in FIG. 6. According to another embodiment, this angle may be 0°, which corresponds to the embodiment of FIG. 7. Finally, according to other alternatives, intermediate angles of 90°, 270° or instead other angles may be envisaged. An advantage is to make the device of the invention totally flexible and adaptable to the projection environment. In all the embodiments, a maintaining element may be used to fasten the lower part with respect to the upper part in order to lock the rotation.

The projection device of FIGS. 6 and 7 inherits all the embodiments described previously of which notably:
the pairing with third-party equipment such as a Smartphone thanks to a wireless component;
the presence of a second colorimetric detector which may be positioned on the projection housing in its upper part or its lower part;
a network component for an internet connection for example;
different algorithms making it possible to detect an interaction point;
different projector technologies;
the presence of a gyroscope and an accelerometer.
Etc.

In the example of FIGS. 6 and 7, it should for example be considered that the parts 2 and 3 of the projection housing form the housing of the bracelet 3 and the band of the bracelet 2. All the characteristics described by means of the examples of the bracelet are thus characteristics that apply to the device of the invention.

According to one embodiment, the emitter 30 on the upper part 3 of the projection housing, notably arranged on part 3 in FIG. 6, may be used when the projection device 1 is used to project onto a surface of a plane Ps. In such a case, the projection device 1 may comprise a removable upper part 3 which makes it possible to obtain a miniaturised projector. The projection housing 1 is thus formed of the single part 3. This embodiment is represented in FIG. 3 wherein the projection is carried out onto a plane Ps. This figure has been described previously by considering the surface Ps as the surface of a forearm 101. The operation of such a projection device 1 is then similar to that of the bracelet 100, the plane of projection being any surface Ps. This embodiment makes it possible to offer an easily transportable travel configuration. In this embodiment, the parts 2 and 5 of the projection housing are optional. The part 2 that forms a tower may be optionally arranged between the upper part of the projection housing 3 and the lower part 5 of the projection housing.

Advantageously, the projection device may be miniaturised so as to make it transportable. According to an exemplary embodiment, the height of the device is less than 10 cm. According to another exemplary embodiment, the height of the device is less than 5 cm.

The projection device of the invention may comprise a power supply source enabling it to be stand-alone. The source is rechargeable for example. According to one embodiment, a battery may be made removable to be recharged directly by a stand-alone charger.

According to another embodiment, the projection device of the invention comprises an interface for connecting an external power supply source.

In the embodiment of FIGS. 6 and 7, the power supply source is not necessarily integrated in the part 2 and 3 of the projection support. The parts 2 and 3 may comprise connectors to be connected to a power supply source comprised in the pedestal 5 or optionally in the tower 2 of the projection device 1.

The memories and the computers making it possible to fulfil the functions of the invention may be comprised:
in the part 2 forming the tower of the projection device 1;
in the part 3 forming a housing comprising the projector 20;
in the part 5 forming the pedestal of the projection device 1.

According to one embodiment, the material of the housing may be made of metal, plastic, wood or any other material making it possible to form a housing.

1. A projection device for displaying interactive digital content intended to be projected onto a surface, the projection device comprising a projection housing including a part forming a support pedestal, said projection housing comprising:
an emitter for emitting a light beam in a non-visible frequency band forming a light sheet that is intended to cover a first zone of a surface;
an image projector for projecting an image onto a second zone;
a first detector for capturing an image of the second zone;
a computer for determining at least one position of at least one interaction point of the light beam by analysis of a trace of the image acquired by the first detector,
wherein the emitter and the first detector are arranged on a lower part of the projection housing and the image projector is arranged on an upper part of the projection housing, said projection housing comprising a rotation system making it possible to pivot the upper part of the projection housing along a vertical axis with respect to the lower part of the projection housing.

2. The projection device according to claim 1, wherein the projection housing comprises a first side comprising the image projector and a second side opposite to the first side on which the emitter and the first detector are arranged, said emitter projecting the light sheet in a direction opposite to an image projection direction.

3. The projection device according to claim 1, wherein the projection housing comprises a first side comprising the image projector, the emitter and the detector, the emitter projecting the light sheet in a direction substantially parallel to the image projection direction, in such a way that the first zone is substantially superimposed on the second zone.

4. The projection device according to claim 1, wherein the detector is configured to record the images comprising at least one interaction trace when the light beam is intercepted by a body, the computer generating interaction instructions modifying the projected image as a function of a detected interaction zone.

5. The projection device according to claim 1, wherein the upper part of the projection housing is removable with respect to its lower part, the upper part of the projection housing being an electronic bracelet comprising an image projector and the lower part being a pedestal supporting said bracelet.

6. The projection device according to claim 5, wherein the bracelet comprises a band intended to be maintained around a wrist, a power supply source and a bracelet housing arranged and maintained on an upper part of the bracelet, said bracelet housing comprising the emitter, the projector, the first detector and the computer.

7. The projection device according to claim 1 further comprising:
a component making it possible to apply deformation factors to the projected image in order to compensate:
a perspective deformation taking into consideration:
lateral deformations of the projected image;
depth of field deformations of the projected image.
a component making it possible to apply deformation factors to the projected image in order to compensate:
a surface deformation linked to an anatomy of a forearm and/or;
a perspective deformation taking into consideration:
lateral deformations of the projected image;
depth of field deformations of the projected image.

8. The projection device according to claim 1, wherein:
the emitter of the light beam is an infrared emitter;
the emitter is a linear emitter projecting a substantially flat light beam.

9. Projection The projection device according to claim 1, wherein the first detector is an infrared detector capturing an image in which the light beam forms an image of which the longitudinal dimensions, that is to say in the projection direction, are identifiable, the first detector further comprising a sensitivity range making it possible to detect a trace caused by an interception of the light beam with a body.

10. The projection device according to claim 1, wherein the position of at least one interaction point is computed from:
a transformation of the image and of the trace acquired into an original image comprising an image of the trace from transformation factors;
a geometric construction of an interaction point of at least one trace or image of the trace.

11. The projection device according to claim 1, wherein the computer is configured to compare compares the position of the interaction point with a matrix of points delimiting interaction zones in a frame of reference linked to the original image, the computer deducing a probability of interaction with an interaction zone.

12. The projection device according to claim 1, further comprising second detector capturing colorimetric images of the second zone.

13. The projection device according to claim 12, further comprising an image stabiliser, said image stabiliser comparing the images acquired by the second detector with the dimensions of a reference image and generating corrective factors to apply to the image deformation factors as a function of the comparison of the images.

14. The projection device according to claim 12, wherein the image stabiliser compares the longitudinal dimensions of the second zone of the images acquired by the first detector with the dimensions of the images acquired by the second detector to generate correction factors to apply to the transformation factors.

15. The projection device according to claim 13, wherein the second detector carries out a second computation of an interaction point by the analysis of a trace intercepting the image, said trace being obtained by analysis of a modification of the colour of the pixels of a portion of the acquired image.

16. The projection device according to claim 15, wherein a computer correlates the position of an interaction point obtained from an image acquired by the first detector and the position of an interaction point obtained from an image acquired by the second detector, the correlation of the positions making it possible to generate a new position of an interaction point.

17. The projection device according to claim 1, wherein:
the image projector is a colour pico-projector,
the image projector comprises a blue laser, a red laser and a green laser and a set of micro-mirrors oriented so as to produce, at each projection point, a point of which the colour is generated by a combination of the three lasers oriented by the mirrors.

18. Projection The projection device according to claim 1, further comprising an accelerometer and a gyroscope making it possible to activate functions generating a modification or a change of the image projected by the projector.
